(19) United States
(12) Patent Application Publication
(10) Pub. No.: US 2002/0130997 A1
(43) Pub. Date: Sep. 19, 2002

(54) Optical film, polarizer and liquid-crystal display device

(75) Inventors: Shuuji Yano, Ibaraki-shi (JP); Seiji Umemoto, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/096,896

(22) Filed: Mar. 14, 2002

(30) Foreign Application Priority Data
Mar. 15, 2001 (JP) P2001-073244

(51) Int. Cl. G02F 1/1335

(52) U.S. Cl. 349/119

(57) ABSTRACT

An optical film having a laminate of a birefringent film A exhibiting refractive index dispersion in accordance with wavelength of light and a birefringent film B exhibiting larger refractive index dispersion in accordance with the wavelength of light than the refractive index dispersion of the birefringent film A, wherein the two birefringent films A and B are laminated on each other so that slow axes of the two birefringent films A and B cross each other perpendicularly in the condition that the two birefringent films A and B are combined with each other so that Re of the birefringent film A is larger than that of the birefringent film B and the sum of Nz of the birefringent film A and Nz of the birefringent film B is in a range of from 0.7 to 1.3 when Re=(nx−ny)d and Nz=(nx−nz)/(nx−ny) in which nz is a refractive index of each of the two birefringent films A and B in a direction of a Z axis expressing a direction of the thickness of the birefringent film, nx is a refractive index of the birefringent film in a direction of an X axis expressing a direction of the maximum refractive index in a plane perpendicular to the Z axis, ny is a refractive index of the birefringent film in a direction of a Y axis expressing a direction perpendicular both to the X axis and to the Z axis, and d is the thickness of the birefringent film.

The present application is based on Japanese Patent Application No. 2001-073244, which is incorporated herein by reference.

### BACKGROUND OF THE INVENTION

1. Field of the Invention

The present invention relates to an optical film in which axial displacement of the laminate hardly occurs in spite of the change of a view point so that the optical film can be used for forming a liquid-crystal display device good in display quality.

2. Description of the Related Art

When a phase retarder disposed between a polarizer and a liquid-crystal cell for improving display quality of a liquid-crystal display device, or a quarter-wave plate used for forming a circularly polarizer or an anti-reflection plate is formed from one birefringent film, birefingence is dispersed in accordance with the wavelength of light on the basis of dispersion peculiar to the material of the retarder or quarter-wave plate. As a result, there is a tendency that the birefringence increases as the wavelength decreases. For this reason, the retardation of the phase retarder or the quarter-wave plate varies in accordance with the wavelength of light, so that the state of polarization cannot change evenly. Under such circumstances, there has been a proposal for an optical film having a laminate of two birefringent films different in birefringence dispersion dependent on wavelength of light so that respective slow axes of the two birefringent films cross each other perpendicularly (Unexamined Japanese Patent Publications No. Hei. 5-27118 and No. Hei. 10-239518).

The proposal is aimed at using the lamination of the birefringent films to control birefringence dispersion dependent on the wavelength of light so that the birefringene decreases as the wavelength decreases. That is, the proposal is provided for obtaining a uniform compensating effect so that a uniform state of polarization is achieved in a wide wavelength range. When observed on an optical axis, the axial relation between the slow axes crossing each other perpendicularly can be kept to fulfill the required effect. On the other hand, when observed from an oblique direction at an azimuth displaced from the optical axis, the perpendicularly crossing axial relation between the slow axes is however corrupted because of the change of the apparent axial angle, so that there is a problem that the required effect cannot be fulfilled and the state of polarization varies. Even in the case where Nz values of the birefringent films are controlled to compensate for axial displacement from the polarizer as disclosed in Unexamined Japanese Patent Publications No. Hei. 5-27118, this measure is not effective in compensating for axial displacement of the laminate of the birefringent film itself.

### SUMMARY OF THE INVENTION

An object of the invention is to develop an optical film in which the axial relation between slow axes crossing each other perpendicularly can be kept good in spite of the change of a view point so that the optical film can be used for forming a liquid-crystal display device good in display quality.

According to the invention, there is provided an optical film having a laminate of a birefringent film A exhibiting refractive index dispersion in accordance with wavelength of light and a birefringent film B exhibiting larger refractive index dispersion in accordance with the wavelength of light than the refractive index dispersion of the birefringent film A, wherein the two birefringent films A and B are laminated on each other so that slow axes of the two birefringent films A and B cross each other perpendicularly in the condition that the two birefringent films A and B are combined with each other so that Re of the birefringent film A is larger than that of the birefringent film B and the sum of Nz of the birefringent film A and Nz of the birefringent film B is in a range of from 0.7 to 1.3 when Re=(nx−ny)d and Nz=(nx−nz)/(nx−ny) in which nz is a refractive index of each of the two birefringent films A and B in a direction of a Z axis expressing a direction of the thickness of the birefringent film, nx is a refractive index of the birefringent film in a direction of an X axis expressing a direction of the maximum refractive index in a plane perpendicular to the Z axis, ny is a refractive index of the birefringent film in a direction of a Y axis expressing a direction perpendicular both to the X axis and to the Z axis, and d is the thickness of the birefringent film. There is further provided a polarizer having a laminate of an optical film defined above and a polarizing film. In addition, there is provided a liquid-crystal display device having a liquid-crystal cell, and at least one polarizer defined above and disposed on at least one surface of the liquid-crystal cell.

According to the invention, birefringent films A and B different in refractive index dispersion dependent on the wavelength of light are combined so that the aforementioned Re and Nz are satisfied while characteristic that the retardation due to birefringence hardly changes on an optical axis in combination of the birefringent films A and B is retained. Hence, the perpendicularly crossing axial relation between optical axes can be retained accurately even in the case where the view point is changed within 360 degrees. It is accordingly possible to obtain an optical film which can fulfill a uniform compensating effect even in the case where the optical film is observed at any azimuth. The optical film can be used for forming a liquid-crystal display device good in display quality.

Features and advantages of the invention will be evident from the following detailed description of the preferred embodiments described in conjunction with the attached drawings.

### BRIEF DESCRIPTION OF THE DRAWING

In the accompanying drawing:

FIG. 1 shows a sectional view of a liquid-crystal display device according to the present invention.

### DETAILED DESCRIPTION OF THE PREFERRED EMBODIMENTS

An optical film 1 according to the invention has a laminate of a birefringent film A (first birefringent film) exhibiting refractive index dispersion in accordance with wavelength of light and a birefringent film B (second birefringent film) exhibiting larger refractive index dispersion in accordance with the wavelength of light than the refractive index dispersion of the birefringent film A, wherein the two birefringent films A and B are laminated on each other so that slow axes of the two birefringent films A and B cross each other perpendicularly in the condition that the two birefringent films A and B are combined with each other so that Re of the birefringent film A is larger than that of the birefringent film B and the sum of Nz of the birefringent film A and Nz of the birefringent film B is in a range of from 0.7 to 1.3 when Re=(nx−ny)d and Nz=(nx−nz)/(nx−ny) in which nz is a refractive index of each of the two birefringent films A and B in a direction of a Z axis expressing a direction of the thickness of the birefringent film, nx is a refractive index of the birefringent film in a direction of an X axis expressing a direction of the maximum refractive index in a plane perpendicular to the Z axis, ny is a refractive index of the birefringent film in a direction of a Y axis expressing a direction perpendicular both to the X axis and to the Z axis, and d is the thickness of the birefringent film. Hereupon, “refractive index dispersion in accordance with the wavelength of light” is equivalent to an inclination of a graph which shows relationship between wavelength of light and refractive index.

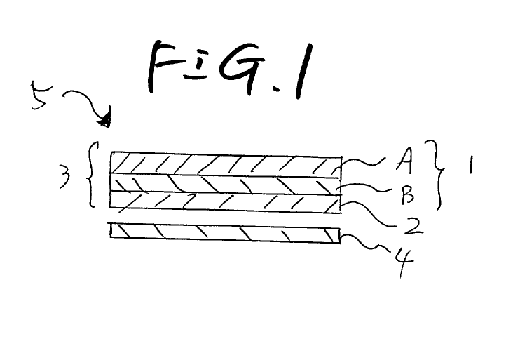

As shown in FIG. 1, the optical film 1 can be formed by a method in which a birefringent film A exhibiting refractive index dispersion in accordance with wavelength of light and a birefringent film B exhibiting larger refractive index dispersion in accordance with the wavelength of light than the refractive index dispersion of the birefringent film A are laminated so that respective slow axes of the two birefringent films A and B cross each other perpendicularly. Accordingly, the two birefringent films A and B are used in combination so that the quantities of refractive index dispersion of the two birefringent films A and B in accordance with the wavelength of light are not equal to each other. Each of the birefringent films may be of a single-layer structure or may be of a multilayer structure in which at least two retardation films are laminated to adjust the refractive index dispersion dependent on the wavelength of light, the retardation, and so on. In the latter case, at least two retardation films constituting one birefringent film A (or B) may be laminated by a method in which the retardation films and the other birefringent film B (or A) or at least two retardation films constituting the other birefringent film B (or A) are disposed alternately. The retardation films constituting one birefringent film A (or B), however, may not be necessarily laminated adjacently to the other birefringent film B (or A) or the retardation films constituting the other birefringent film B (or A), respectively. Incidentally, the perpendicularly crossing axial relation is preferably formed so that the respective slow axes of the two birefringent films cross each other as perpendicular as possible though axial displacement caused by working error can be allowed. When there is variation in the direction of the slow axis of each birefringent film, the slow axis is determined on the basis of the average direction thereof.

A suitable film can be used as each of films constituting the birefringent film without any particular limitation. Examples of the suitable film include: a film of a polymer such as polycarbonate, polypropylene, polyester, polyvinyl alcohol, polymethyl methacrylate, polyether-sulfone, polyallylate or polyimide; and a film composed of an isotropic base material, and an inorganic or liquid-crystal material applied on the isotropic base material. Especially, a film excellent in transparency (light transmittance) is preferred. The birefringent film made of a polymer film may be obtained, for example, as a drawn film subjected to a suitable drawing process such as a uniaxial process or a biaxial process.

The birefringent films A and B may be simply stacked up. From the point of view of preventing displacement of optical axes, it is however preferable that the birefringent films A and B are laminated so as to be adhesively fixed to each other. A suitable method can be employed for lamination of the birefringent films A and B without any particular limitation. For example, any suitable method such as a bonding method using an adhesive agent (inclusive of tackifier, glue, etc.) excellent in transparency may be employed as the lamination method. The kind of the adhesive agent is not particularly limited too. From the point of view of preventing the change of optical characteristic of each birefringent film, an adhesive agent not requiring any high-temperature process for curing and drying is preferred and an adhesive agent not requiring any long-term curing and long-term drying is preferred.

The method preferably used in the case where the birefringent films A and B are laminated so that their slow axes cross each other perpendicularly is a method using lyotropic liquid crystal and particular lyamethod using lyotropic liquid crystal for forming the birefringent film B. Incidentally, in the case where the birefringent films A and B constituted by drawn films respectively are laminated on each other in the state that their slow axes cross each other perpendicularly, the drawn films are cut and aligned accurately so that work of such drawing films in a batch process is troublesome. On the other hand, lyotropic liquid crystal exhibiting shear orientation force has such characteristic that its slow axis appears in a direction perpendicular to the direction of application of the lyotropic liquid crystal. When, for example, lyotropic liquid crystal is applied along the drawing axis of the birefringent film A, slow axes crossing each other perpendicularly can be formed easily. Hence, the use of lyotropic liquid crystal can simplify the laminating work and is excellent in production efficiency. Further, a coating method is advantageous in terms of reduction in thickness because it is unnecessary to provide any adhesive agent separately when the coating method is used for adhesive lamination. In addition, a suitable lyotropic liquid crystal material exhibiting the shear orientation force can be used for the lyotropic liquid crystal.

In the case where the optical film is formed according to the invention, in addition to the relation that the two birefringent films A and B different in refractive index dispersion dependent on the wavelength of light are laminated so that their slow axes cross each other perpendicularly, the two birefringent films A and B are combined with each other so that Re of the birefringent film A is larger than that of the birefringent film B and the sum of Nz of the birefringent film A and Nz of the birefringent film B is in a range of from 0.7 to 1.3 when Re=(nx−ny)d and Nz=(nx−nz)/(nx−ny) (the same rule applies hereunder) in which nz is a refractive index of each of the two birefringent films A and B in a direction of a Z axis expressing a direction of the thickness of the birefringent film, nx is a refractive index of the birefringent film in a direction of an X axis expressing a direction of the maximum refractive index in a plane perpendicular to the Z axis, ny is a refractive index of the birefringent film in a direction of a Y axis expressing a direction perpendicular both to the X axis and to the Z axis, and d is the thickness of the birefringent film.

In such a manner, there can be obtained an optical film in which optical axes of the two constituent films never change from predetermined directions in spite of observation at any azimuth, that is, optical axes of the two constituent films always cross each other perpendicularly regardless of the direction of observation so that there is no change of the axial direction from a predetermined angle. On this occasion, combination of the film A having a large value of Re and the film B having a small value of Re makes it possible to form an optical film exhibiting suppressed refractive index dispersion dependent on the wavelength of light. The optical film preferred from the point of view of achieving this characteristic highly accurately is constituted by birefringent films A and B which are combined with each other so that the sum of Nz values is in a range of from 0.8 to 1.2, especially in a range of from 0.9 to 1.1, further especially about 1.0. The especially preferred optical film is formed by use of birefringent films A and B each having Nz of about 0.5.

It will go well if the birefringent films A and B are different from each other in any one of constituent material, refractive index (birefringence) dispersion dependent on the wavelength of light and Nz. The birefringent films A and B are regarded as one and the same film if they are equal to each other in all of these factors. Incidentally, Re can be controlled, for example, on the basis of constituent material, film-drawing condition, film thickness, and so on. On the other hand, Nz can be controlled by a method of controlling the refractive index of the film in the direction of the thickness of the film. For example, Nz can be controlled by a method in which a film of a polymer such as polycarbonate capable of forming a slow axis in a direction of orientation of molecules and exhibiting positive birefringence is drawn by curing (hardening) the polymer while orientation of the polymer is controlled by application of an electric field in a direction of the thickness of the film.

The optical film can be used for forming a circularly polarizer and for rotating the azimuth (plane of vibration) of linearly polarized light. The optical film preferably used in these cases has an in-plane retardation (Re of the optical film as a whole) in a range of from 100 to 350 nm, especially in a range of from 110 to 330 nm, further especially in a range of from 120 to 300 nm.

As shown in FIG. 1, the optical film 1 may be laminated on a polarizing film 2 to form a polarizer 3 when it is put into practical use. The polarizer thus formed has an advantage in that the state of polarization can be changed evenly regardless of the wavelength of light. In this case, the relation between axial angles in the laminate is not particularly limited but it is generally preferable that the absorption axis of the polarizing film and the optical axis of the optical film cross each other at an angle of 45 degrees.

A suitable material can be used as the polarizing film without any particular limitation. Examples of the material generally used include: a film formed by adsorbing iodine or a dichromatic substance such as dichromatic dye onto a hydrophilic polymer film such as a polyvinyl alcohol film and drawing the hydrophilic polymer film; and a polyene-oriented film obtained by processing a film of a polymer such as polyvinyl alcohol. The polarizing film may be provided with one transparent protective layer made of a triacetyl cellulose film or the like and disposed on one or each of opposite surfaces of the polarizing film.

A suitable method can be applied to the lamination of the optical film and the polarizing film without any particular limitation. Various kinds of methods using adhesive agents as listed above in the description of the lamination of the birefringent films A and B can be applied to the lamination of the optical film and the polarizing film. Incidentally, the optical film may be provided so that it serves also as a transparent protective layer on the polarizing film. The optical film may be provided on one or each of opposite surfaces of the polarizing film. Generally, the optical film is provided on one of opposite surfaces of the polarizing film. In this case, a resin coating layer, an anti-reflection layer, an anti-glare layer, etc. may be provided on the surface of the polarizing film opposite to the optical film side surface of the polarizing film for the purpose of protection such as water resistance as occasion demands.

The polarizer 3 constituted by a laminate of the optical film 1 and the polarizing film 2 can be preferably used for forming a liquid-crystal display device 5. As shown in FIG. 1, the formation of the liquid-crystal display device 5 can be performed by arrangement of the polarizer 3 on one or each of opposite surfaces of a liquid-crystal cell 4. The liquid-crystal cell used is optional. A suitable liquid-crystal cell such as an active matrix drive type liquid-crystal cell represented by a thin-film transistor type liquid-crystal cell or a passive matrix drive type liquid-crystal cell represented by a twisted nematic (TN) type or super-twisted nematic type liquid-crystal cell can be used as the liquid-crystal cell.

The polarizer can be used for various kinds of purposes in accordance with the retardation characteristic of the optical film contained in the polarizer. Incidentally, in a display device using reflective TN liquid crystal, there is the case where circularly polarized light may be made incident on the liquid-crystal cell for the purpose of improving display quality. In this case, the polarizer according to the invention can be disposed as a circularly polarizer to achieve good display quality free from coloring in a black display state. In addition, the polarizer can be used to compensate for the retardation due to the liquid-crystal cell to thereby improve display quality such as widening of the viewing angle.

### Example 1

A birefringent film A1 made of a uniaxially drawn film of polyvinyl alcohol, exhibiting refractive index dispersion in accordance with the wavelength of light and having Re of 500 nm and Nz of 1, and a birefringent film B1 made of a drawn film of polycarbonate, exhibiting larger refractive index dispersion in accordance with the wavelength of light than the refractive index dispersion of the birefringent film A1 and having Re of 230 nm and Nz of 0 were adhesively laminated on each other through a tackifier so that respective retarded axes of the two birefringent films A1 and B1 crossed each other at 90 degrees. Thus, an optical film exhibiting an in-plane retardation of 270 nm was obtained.

### Example 2

A birefringent film A2 made of a drawn film of polynorbornene, exhibiting refractive index dispersion in accordance with the wavelength of light and having Re of 300 nm and Nz of 0.5, and a birefringent film B2 made of a drawn film of polycarbonate, exhibiting larger refractive index dispersion in accordance with the wavelength of light than the refractive index dispersion of the birefringent film A2 and having Re of 160 nm and Nz of 0.5 were adhesively laminated on each other through a tackifier so that respective retarded axes of the two birefringent films A2 and B2 crossed each other at 90 degrees. Thus, an optical film exhibiting an in-plane retardation of 140 nm was obtained.

### Comparative Example 1

A uniaxially drawn film of polyvinyl alcohol having Re of 500 nm and Nz of land a uniaxially drawn film of polycarbonate having Re of 230 nm and Nz of 1 were adhesively laminated on each other through a tackifier so that respective retarded axes of the two drawn films crossed each other at 90 degrees. Thus, an optical film exhibiting an in-plane retardation of 270 nm was obtained.

Evaluation Test 1

The angle between respective optical axes of the two drawn films contained in the optical film obtained in each of Examples 1 and 2 and Comparative Example 1 was measured in the condition that the optical film was inclined at an angle of 70 degrees with respect to an azimuth of 45 degrees from the respective optical axes of the two drawn films. As a result, it was found that the angle of 90 degrees was kept constant without any axial displacement in each of Examples 1 and 2 whereas axial displacement of 14 degrees occurred in Comparative Example 1.

### EXAMPLE 3

The optical film obtained in Example 2 and a polarizing film were laminated on each other through an adhesive layer so that the optical axis of the optical film and the absorption axes of the polarizing film crossed each other at an angle of 45 degrees. Thus, a circularly polarizer was obtained.

### COMPARATIVE EXAMPLE 2

A circularly polarizer was obtained in the same manner as in Example 3 except that the optical film obtained in Comparative Example 1 was used.

Evaluation Test 2

The state of polarization of light transmitted through the circularly polarizer obtained in each of Example 3 and Comparative Example 2 was measured in an obliquely viewing direction at an azimuth of the absorption axis of the polarizing film and at an angle of 70 degrees with respect to a line normal to the polarizing film. As a result, it was found that the absolute value of an S3 component in stroke parameters standardized on the basis of an S0 component regarded as 1 was in a range of not smaller than 0.97 (relative to the maximum value of 1.0, which maximum value applied hereunder) in a visible light range in Example 3 whereas the absolute value of the S3 component varied widely in a range of not smaller than 0.73 in Comparative Example 2. Incidentally, in the direction of the normal line, the range of the absolute value of the S3 component in Example 3 and that in Comparative Example 2 were substantially equal to each other, that is, both the circularly polarizer obtained in Example 3 and the circularly polarizer obtained in Comparative Example 2 exhibited excellent characteristic.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. An optical film comprising:
a first birefringent film exhibiting refractive index dispersion in accordance with wavelength of light; and
a second birefringent film laminated on said first birefringent film and exhibiting larger refractive index dispersion in accordance with the wavelength of light than said refractive index dispersion of said first birefringent film,
wherein said first and second birefringent films are laminated on each other so that slow axes of said first and second birefringent films cross each other perpendicularly in a condition that said first and second birefringent films are combined with each other so that Re of said first birefringent film is larger than that of said second birefringent film and the sum of Nz of said first birefringent film and Nz of said second birefringent film is in a range of from 0.7 to 1.3 when Re=(nx−ny)d and Nz=(nx−nz)/(nx−ny) in which nz is a refractive index of each of said first and second birefringent films in a direction of a Z axis expressing a direction of a thickness of said birefringent film, nx is a refractive index of said birefringent film in a direction of an X axis expressing a direction of a maximum refractive index in a plane perpendicular to said Z axis, ny is a refractive index of said birefringent film in a direction of a Y axis expressing a direction perpendicular both to said X axis and to said Z axis, and d is the thickness of said birefringent film.

2. An optical film according to claim 1, wherein Nz of said first birefringent film and Nz of said second birefringent film are both equal to about 0.5.

3. An optical film according to claim 1, wherein said second birefringent film is made of lyotropic liquid crystal.

4. An optical film according to claim 1, wherein the in-plane retardation of said optical film is in a range of from 100 to 350 nm.

5. A polarizer comprising a laminate of an optical film according to claim 1 and a polarizing film.

6. A liquid-crystal display device comprising a liquid-crystal cell, and at least one polarizer according to claim 5 and disposed on at least one surface of said liquid-crystal cell.
